(19) United States
(12) Patent Application Publication
(10) Pub. No.: US 2010/0177670 A1
(43) Pub. Date: Jul. 15, 2010

(54) RESOURCE ALLOCATION IN A COMMUNICATION SYSTEM

(75) Inventor: Ari Tapani Hottinen, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/686,559

(22) Filed: Jan. 13, 2010

(30) Foreign Application Priority Data
Jan. 14, 2009 (GB) 0900572.9

(51) Int. Cl. H04L 5/14; H04J 3/22

(52) U.S. Cl. 370/294; 370/276; 370/468

(57) ABSTRACT

The disclosure relates to resource allocation. In accordance with the disclosed method first information regarding a first direction of a duplex communication link and second information regarding a second direction of the duplex communication link is provided for a node. The first information and the second information are processed, and channel resources are allocated for the first direction and the second direction of the duplex communication link based at least partially on said processing.

### RELATED APPLICATION

This application claims priority to GB Application No. 0900572.9, which is incorporated herein by reference in its entirety.

### TECHNICAL FIELD

The exemplary and non-limiting embodiments for this invention relate generally to communication systems, methods, devices and computer programs, and more particularly to allocation of resources in a communication system.

### BACKGROUND

A communication system can be seen as a facility that enables communication sessions between two or more entities such as user communication devices, network entities and/or other nodes associated with the communication system. Non-limiting examples of communication systems include fixed line communication systems, such as a public switched telephone network (PSTN) and local area networks (LAN), and wireless communication systems, such as a public land mobile network (PLMN), satellite based communication systems and different wireless local systems such as wireless local area networks (WLAN). A communication system and compatible communication devices typically operate in accordance with a given standard or specification which sets out what the various entities associated with the system are permitted to do and how that should be achieved. For example, the standard or specification may define if communication is provided with a circuit switched carrier service or a packet switched carrier service or both and protocols, technologies and/or parameters that shall be used for the communications.

Communication systems typically allow multiple users to communicate simultaneously, that is, more than two nodes that are communicating with each other may simultaneously communicate in a particular communication environment. The multi-user scenario needs to be taken into account when designing and operating a communication system. For example, available communication resources may need to be divided, or allocated, between the communication nodes based on some rule, and interference caused by and/or caused to the other nodes may also need to be considered.

A user can access the communication system by means of an appropriate communication device. A communication device of a user is often referred to as user equipment (UE). A communication device is provided with an appropriate signal receiving and transmitting arrangement for enabling communications with other parties via appropriate communication channels. Typically a communication device is used for enabling the users thereof to receive and transmit communications such as speech and data. In wireless systems a communication device provides a transceiver station that can communicate with e.g. a base station of an access network and/or another communication device. Depending on the context a communication device or user equipment may also be considered as being a part of a communication system. In certain applications, for example in adhoc networks, the communication system can be based on use of a plurality of user equipment capable of communicating with each other.

The communication may comprise, for example, communication of data for carrying communications such as voice, electronic mail (email), text message, multimedia and other content data and so on. Users may thus be offered and provided numerous services via their communication devices. Non-limiting examples of these services include two-way or multi-way calls, data communication or multimedia services or simply an access to a data communications network system, such as the Internet.

The capacity of a multi-channel multi-user system can be interference-limited. That is, the interference caused by the other users may restrict the available capacity and other resources. Interference depends, among other interferers, on transmitters in the vicinity of the receivers, and hence can be different for different nodes. Intra node interference may also exist for example where transmitters and/or receivers in a multi-radio user equipment interfere with each other. Thus, two nodes in duplex communication with each other can have substantially different interferers affecting them. As a result, in a multi-user system different nodes in duplex communication can experience a different signal quality, for example a different signal-to-interference ratio (SIR) as interference and effective channel is not typically reciprocal. That is, a channel that is seen at a receiver including various transmit and receive filters, physical channel and interference can be different in different positions in a communication system. These issues can affect the signal quality in the occupied subchannels, sometimes even considerably. This non-reciprocality may not only affect the link parameters, such as achievable transmission rate or quality on a given non-reciprocal subchannel, but it may also make it difficult for the system to determine how to allocate a plurality of subchannels and other channel resources to different users or links or link directions.

Optimizing the opposite links, for example an uplink and a downlink, separately may work fine as long as the carrier or subchannels can be freely changed between all slots in both directions. However, this may not be the case due to various resource and signalling constraints. Moreover, due to non-reciprocal channels, different duplex dimensions may support different data rates and/or data quality. At the same time, different duplex dimensions may have different data rate requirements. For example, these two requirements/issues may need to be optimized and/or taken into account when allocating resources so that capacity is not unnecessarily wasted in a duplex direction of a link.

It is noted that the above discussed issues are not limited to apy particular communication environment, but may occur in any appropriate communication system where duplex communication may be provided in multi-user environment.

### SUMMARY

Embodiments of the invention aim to address one or several of the above issues.

In accordance with an embodiment there is provided a method comprising receiving first information regarding a first direction of a duplex communication link, receiving second information regarding a second direction of the duplex communication link, processing the first information and the second information, and allocating channel resources for the first direction and the second direction of the duplex communication link based at least partially on said processing.

In accordance with another embodiment there is provided an apparatus comprising means for receiving first information regarding a first direction of a duplex communication link, means receiving second information regarding a second direction of the duplex communication link, means for processing the first information and the second information, and means for allocating channel resources for the first direction and the second direction of the duplex communication link based at least partially on said processing.

In accordance with more specific embodiments, the channel resource may comprise a channel, subchannel, carrier frequency, a time slot, a time-frequency slot, a transmit beam, and/or a receive beam.

A joint allocation parameter may be determined. Resources can be allocated based on the joint allocation parameter.

Said first and second information may comprise at least one of channel information and interference information and/or other channel specific information. The channel specific information may comprise at least one of information regarding channel power, signal to interference ratio, bit error rate, channel capacity, channel throughput, channel utilization, channel specific buffer, channel quality, channel occupancy, channel availability, tolerable delay, channel state information, subchannel preferences, and data rate demands.

At least one of the first information and the second information can be weighted.

The processing of the first and second information may comprise combining information based on at least one of additive, non-additive or multiplicative combining.

The second information may be determined by a receiving node. The receiving node may communicate the second information from to a transmitting node. The first information may be determined by the transmitting node. The transmitting node may also receive the second information and process the first and second information to allocate channel resources.

The allocation of resources may be based on information regarding at least one further communication link. Resources may be allocated for at least one other link based on processing of at leas said first and second information.

Channel resources may be allocated at both ends of the duplex communication link based on the same allocation algorithm and input information.

In accordance with an embodiment there is provided a computer program comprising program code means adapted to perform the allocation when the program is run on a data processing apparatus.

In accordance with a yet further embodiment there is provided an apparatus comprising an interface for receiving a first information regarding a first direction of a duplex communication link from a transmitting node and for sending a second information regarding a second direction of the duplex communication to the transmitting node. The apparatus also comprises at least one data processor for determining the second information, for processing the first information and the second information, and for allocating channel resources for the second direction of the duplex communication link based at least partially on said processing.

Various other aspects and further embodiments are described in the following detailed description and in the attached claims.

### BRIEF DESCRIPTION OF THE DRAWINGS

In the attached Drawing Figures:

FIG. 1 shows an example of a communication system in which the exemplary embodiments of the invention may be implemented;

FIG. 2 illustrates a duplex link between two nodes;

FIG. 3 shows a partially sectioned communication device;

FIG. 4 shows an example of a controller apparatus in accordance with an exemplary embodiment;

FIGS. 5 and 6 are flowcharts illustrating certain exemplary embodiments; and

FIG. 7 shows results of simulations.

### DETAILED DESCRIPTION

The invention will be described in further detail, by way of example only, with reference to the following examples and accompanying drawings.

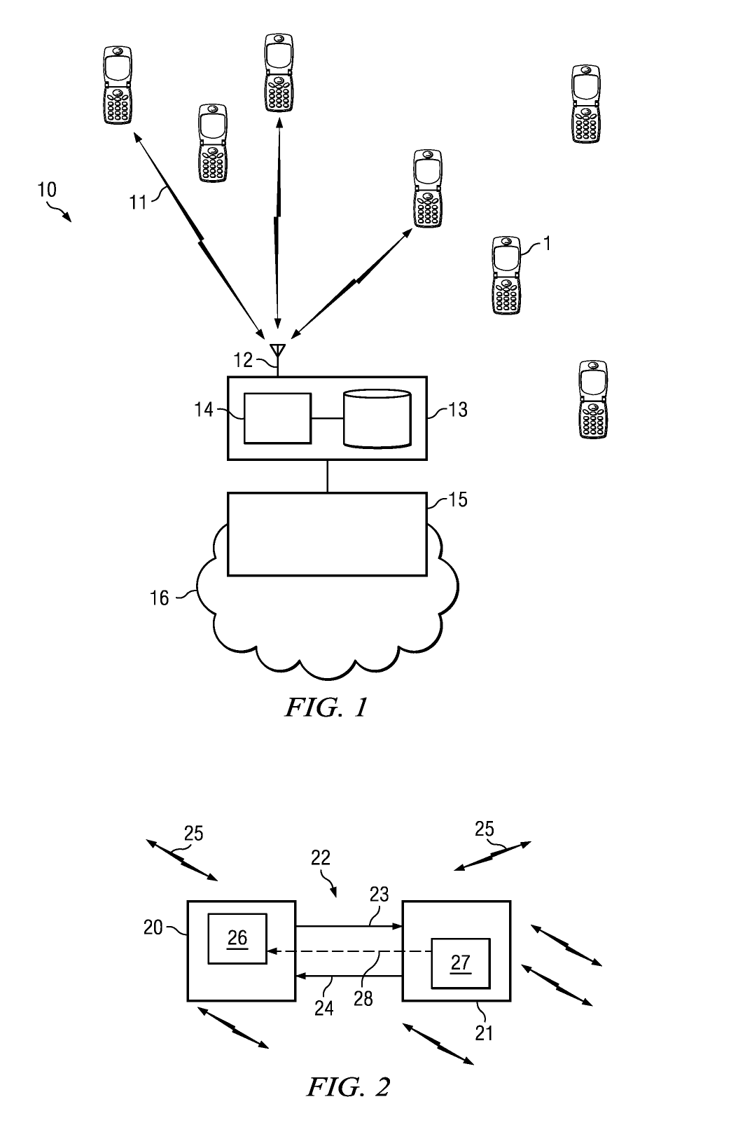

Before explaining in detail the certain exemplifying embodiments, certain general principles of wireless communication and communication between nodes in general are briefly explained with reference to FIGS. 1, 2, and 3. In the following certain exemplifying embodiments are explained with reference to wireless communication systems where communication devices may communicate with access points provided by base stations and/or other communications devices.

A communication device can be used for accessing various services and/or applications. For example, communication devices 1 of FIG. 1 can access a data or another service network 16 via a gateway apparatus 15 and an access system 10. More particularly, FIG. 1 shows a plurality of communication devices 1 in wireless communication with an access system 10 of a wireless communication system. A wireless communication device 1 can typically be provided with the access via at least one base station 12 or similar wireless transmitter and/or receiver node of the access system 10. Each communication device 1 may have one or more radio channels open at the same time, may be in duplex communication with the base station 12 and may receive signals from more than one base station and/or other communication device. The duplex communication links in the multi-user environment of FIG. 1 are illustrated by the double headed arrows 11.

FIG. 2 shows a duplex communication link 22 between nodes 20 and 21. The link 22 is provided by link 23 from a first node 20 to a second node 21 and link 24 from the second node 21 to the first node 20. The duplex communication link can be arranged so that the same channel or slot is used for communication in both directions. Examples of such links are discussed in more detail later in this specification.

FIG. 2 shows also radio signals 25 by interferers, for example by other transmitting stations. As shown, nodes 20 and 21 at the opposing ends of the duplex link 22 can experience substantially different interference. The interference can, for example, be caused by different sources of interference, by a different number of interferers, be of different nature and/or strength, and so on.

The first node 20 is shown to comprise apparatus 26 for allocating channel resources, for example channels, subchannels and/or slots for the duplex link 22. Further examples of the channels resources include transmit and/or receive beams, for example in a system employing space division multiple access (SDMA) and/or multiple input multiple output (MIMO) resources. The apparatus can receive channel specific information regarding the link 23 from the second node 21, and more particularly from measuring apparatus 27 of the second node. This information flow is indicated by the dashed arrow 28. The allocation apparatus 26 of the first node 20 is also provided with channel information regarding the second or reverse link 24. The apparatus 26 of the first node 20 may measure or otherwise determine this information, or the information can be received from other control apparatus associated with the first node 20.

The channel specific information can thus be provided by both the first node and the second node. The information is typically obtained based on measurements on the received signal, possibly including training sequences or pilot tones. The measurements can be provided, for example, by means of known techniques. The information may be provided for example as a parameter, by a function of the particular information and/or combination of various pieces of information.

The channel specific information may for example comprise information regarding channel power, signal to interference ratio (SIR), capacity, throughput, channel utilization, a quality measure, for example a parameter such as quality of service (QoS), bit error rate (BER), channel quality indicator (CQI) and so on. Channel occupancy information and/or an indication if a channel is available or not (e.g. busy tone) may also be used as channel specific information. Alternatively, or in addition, information relation to a tolerable transmission delay can be utilised. Channel specific information may also be provided in the form of channel state information (CSI).

A measure associated with a channel specific buffer may also be used as a basis in the allocation procedure. For example, a parameter defining how much data there is to transmit and/or required capacity for emptying the buffer may be used. In accordance with an exemplifying embodiment an empty transmission buffer can be indicated by related channel and channel specific information. This may be useful because even a high quality channel in a given duplex direction can be poor in terms of channel utilization (CU), if the node in question has no data to send.

Subchannel preference information may be advantageously utilised in certain embodiments. In such embodiments a receiver node may determine from measurements a ranking of subchannels. For example, it can be determined that subchannel 1 is best in terms of selected performance or utility criteria, subchannel 2 third best, subchannel 3 second best and so on.

In accordance with a possible scenario a throughput-based channel utilization measure may take the minimum of target data rate and channel supported data rate. The target data rate could be set to zero if there is no data to be send. This can be determined by the transmitting node.

Both the transmitting and the receiving node can provide information associated with the interference experienced by the associated channels and on other channel specific information parameters.

A combining function can consider information associated with both duplex directions, in other words combine multiple criteria, when determining subchannel (for example collection of subcarriers, time slots and so on) allocation. The multiple criteria may be combined into one joint criterion using an application specific function, such as weighted average of two sets of information, minimum/maximum of two sets of information, or any other function.

In accordance with an embodiment the channel specific information of both duplex directions can be used and the required combining action taken in one or both ends of a duplex link. If allocation is computed only in one end, then the decision can be signalled to the other end via an appropriate communications channel.

In the latter case information affecting allocation of a joint channel can be provided for allocation apparatus at both ends of a duplex link and the computation of the allocation may be provided in both ends of the duplex link. The link ends can be provided with identical information affecting the allocation, and the allocation apparatus at both ends may thus also calculate the allocation separately. The result is the same because the same algorithm and input information are used by both allocation apparatus. A multi-user solution in accordance with this embodiment may require only limited signalling, as only predefined information, for example a predefined quality or other parameter, for example a channel quality and/or capacity indicator, preference information, or similar, needs to be signalled in both directions. Allocation apparatus at the nodes at both ends of the link can then compute the allocations using the same algorithm and combining the same input information.

In wireless access systems the opposite links are often referred to as downlink or forward link and uplink or reverse link. The downlink/forward link is commonly understood to refer to the wireless link from a base station or similar and the uplink/reverse link to the link towards the base station or similar. However, similar principles of bi-directional links apply also to, for example, situations where two or more equal nodes, for example two user devices or two network or mesh nodes are in duplex communication as applies to a downlink-uplink duplex link.

A base station or another access point is typically controlled by at least one appropriate controller entity so as to enable operation thereof and management of mobile communication devices in communication with the base station. The controller entity is typically provided with memory capacity and at least one data processor. The control entity can be interconnected with other control entities. In FIG. 1 the controller is shown to be provided by block 13. The controller apparatus may comprise at least one appropriate processor 14 and memory. It shall be understood that the control functions can be distributed between a plurality of controller units and/or can be shared by a plurality of base stations.

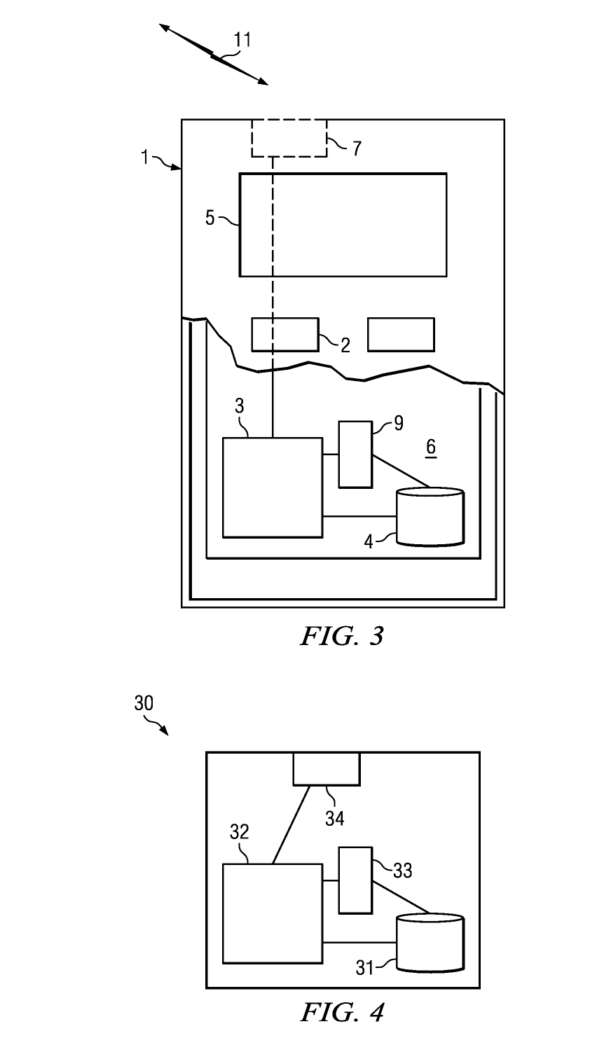

FIG. 3 shows a schematic, partially sectioned view of a communication device 1 that can be used for communication with at least one base station of an access system and/or another node. An appropriate communication device may be provided by any device capable of sending and receiving radio signals based on duplexing. Non-limiting examples include a mobile station (MS), a portable computer provided with a wireless interface card or other wireless interface facility, personal data assistant (PDA) provided with wireless communication capabilities, or any combinations of these or the like. A wireless mobile communication device is often referred to as a user equipment (UE).

The communication device 1 may be used for service such as voice and video calls and/or for accessing service applications. The device 1 may receive and transmit duplex communication signals 11 via an appropriate radio transceiver of the mobile device. In FIG. 3 the transceiver is designated schematically by block 7. The transceiver may be provided for example by means of a radio part and associated antenna arrangement. The antenna arrangement may be arranged internally or externally to the mobile device. The communication device 1 may be configured for enabling tuning to different carrier frequencies.

A communication device is also typically provided with at least one data processing apparatus 3, at least one memory 4 and other possible components 9 for use in tasks it is designed to perform. The data processing, storage and other entities can be provided on an appropriate circuit board and/or in chipsets. This feature is denoted by reference 6. The user may control the operation of the mobile device by means of a suitable user interface such as key pad 2, voice commands, touch sensitive screen or pad, combinations thereof or the like. A display 5, a speaker and a microphone are also typically provided. Furthermore, a mobile device may comprise appropriate connectors (either wired or wireless) to other devices and/or for connecting external accessories, for example hands-free equipment, thereto.

The communication devices 1 can access the system 10 based on various access techniques, for example code division multiple access (CDMA), wideband CDMA (WCDMA), time division multiple access (TDMA), frequency division multiple access (FDMA), orthogonal frequency division multiple access (OFDMA), space division multiple access (SDMA) and so on. Combinations of these and/or different access techniques are also possible.

FIG. 4 shows a more detailed example of a controller apparatus 30 in accordance with an exemplary embodiment. The apparatus may comprise at least one memory 31, at least one data processing unit 32, 33 and an input/output interface 34. The controller may be configured to execute an appropriate software to provide the desired control function to provide a resource allocation apparatus in accordance with one or more of the embodiments in accordance with the invention. For example, the apparatus 30 may be configured to optimise use of resources by allocating channels, carrier frequencies, subchannels or subcarriers, timeslots and/or time-frequency slots jointly for both directions of a duplex link based on information regarding both directions of the link.

In duplex communication a transceiver node is typically able to send and receive at substantially the same time. To enable this an appropriate scheme for separating the signals to and from a device is provided. The separation can be provided by applying a multiplexing scheme to communications to and from a transceiver. Time-Division Duplex (TDD) is example of an application of time-division multiplexing where outward and return signals are separated based on time. The time-division multiplexing emulates full duplex communication over a half duplex communication link. In time-division duplexing time-division multiplexing (TDM) is applied to separate outward and return signals. Time-Division Multiplexing (TDM) is a type of digital or analog multiplexing in which two or more signals or bit streams are transferred apparently simultaneously as sub-channels in one communication channel, but are physically taking turns on the channel. The time domain is divided into several recurrent timeslots of fixed length, typically one for each sub-channel. A sample byte or data block of a sub-channel can be transmitted during a first timeslot (timeslot 1), a second sub-channel during a second timeslot (timeslot 2), and so on. One TDM frame can consist of one timeslot per sub-channel. After the last sub-channel the cycle starts again with a new frame, starting with the second sample, byte or data block from the first sub-channel, and so on. Time-division duplex is considered as having particular advantage if there is asymmetry of the data rates in the duplex links. As the amount of data increases in one of the links, more communication capacity can dynamically be allocated to that link, and as the demand becomes lower capacity can be adjusted accordingly. The concept can be applied to wired and wireless systems.

In accordance with an exemplary embodiment the channel allocation or assignment is applied to a TDD system. Channel assignment refers in this example to a case where TDD uplink and TDD downlink communication links use the same carrier, subcarrier, or set of subcarriers or subchannels, in both uplink and downlink directions. More precisely, if a TDD slot 1 subchannels Fᵤₚ=fᵢ₁, . . . , f_{iN} are used in uplink, then the same subchannels or subcarriers are used in slot 2, or in any corresponding downlink slot. That is, the same subchannels are used in downlink and uplink for communication between the two nodes, i.e. Fᵤₚ=F_{Down}.

The herein disclosed principles can be applied to other duplexing techniques as well, for example frequency-division duplexing (FDD). In frequency-division duplex (FDD) type operation the transmitter and receiver nodes operate at different carrier frequencies, and the sub-bands in different directions are separated by an offset in the frequency.

The herein disclosed principles can also be applied to hybrid techniques. For example, channel resource can be allocated in a joint Time-Division Multiplexing (TDM) system and orthogonal frequency division multiple access (OFDMA) system. In a TDM based system subchannels correspond to time slots whereas in a hybrid TDM each subchannel is a time-frequency slot. OFDMA is a multi-user version of the Orthogonal frequency-division multiplexing (OFDM) digital modulation scheme. Multiple access is achieved in OFDMA by assigning subsets of subcarriers to individual users.

The disclosed resource allocation method and apparatus can also be applied to e.g. CDMA/TDD or OFDM/TDD systems where the system needs to decide the carrier assignments among the simultaneously transmitting users/nodes. For example, a decision may need to be made which wideband channels (e.g. 5 MHz channels) to use among at least two alternatives. For example, there may be several 5 MHz channels assigned to a given system, e.g. as in multi-carrier/band transmission systems. Different carriers among the plurality of carriers lead to different channels specific information in different link directions.

The transceiver part of the communication device of FIG. 3 can be configured to provide any one of these techniques, or any other appropriate duplexing technique.

The following describes a few examples how channels resource allocation can be provided in a communication system, for example in a communication system that is based on the Time-Division Duplex (TDD) or Frequency-Division Duplex (FDD) by using joint information regarding both duplex directions. The duplex links can be provided, for example, between one or multiple devices and a base station or another access point, or between communication devices. In the following examples the same channel or slot is being used for both directions of the duplex link.

In certain embodiments performance indicators can be provided for both directions of at least one duplex link and these can then be used by an allocation function to generate a common performance or channel utility indicator. The common indicator may then be used in allocating channels and/or subchannels and/or timeslots and/or frequency slots for at least one duplex link, for example a bi-directional link. The indicators may be computed for different users or services using different subchannels. Multiple subchannels, possibly in different duplex directions, may be simultaneously active, and each of these may be allocated to different users and/or services such that bi-directional channel utility can be improved.

Because of non-reciprocal interference, as shown for example in FIG. 2, efficient allocation of subchannels or other channel resources in a TDD based system may require a feedback link for communicating channel information 28 from the receiver node 21 to the transmitter node 20. Communication systems can provide such feedback links. For example, in FDD and TDD based systems feedback links suitable for this purpose are typically provided for link adaptation purposes, for example for determining of modulation, coding, power parameters and so on. The feedback can be provided via the return link 24, or a separate communication path 28 may be provided, depending on the application.

In an exemplary embodiment a receiving communication device can be configured to measure appropriate received channel(s), for example pilot channel(s). The receiving communication device may then compute its respective performance measures or utilities based on the measurements, and signal information related to this measurement to one or more transmitters of the channel(s). For example, a mobile user device may report such information in uplink together with pilot signals. The allocation apparatus of the transmitter can then combine the signalled information with information estimated from e.g. pilot signals. The transmitter node may also collect further information, and use that in the channel resource allocation.

The allocation apparatus may also collect information associated with at least two different users or services, and make a channel assignment decision for said at least two users/services. For example, in FIG. 1 the base station 12 can be in duplex communication with a plurality of user communication devices 1, and the controller thereof may allocate channel resources to a plurality of the duplex links 11 at once.

Another use example relates to a single-carrier/TDD system with P simultaneous users in P different carriers. The carrier can be orthogonal, for example. In this case the system can decide the operating carrier frequency for all P users based on information regarding both directions of at least one duplex link. Once the frequency is determined, each node pair (e.g. one access point and P devices) can operate using time division duplexing (TDD) independently of each other.

In a method according to an exemplary embodiment, allocation of a carrier can be made dependent on performance indicators associated with a duplex link, e.g. a link from a first node to a second node and a second link from the second node to the first node.

The functional form of the indicator in each duplex end can depend on the application, target and the system. Two indicators can be named, for example

Φᵤₚ[p,p′],

for performance when letting user p transmit in uplink on carrier (or subchannel) p′. Similarly, one can have

Φ_{down}[p,p′]

for performance when letting user p transmit in downlink on carrier (or subchannel) p′. The same carrier can be used on both duplex directions, and thus for joint optimization, the joint performance indicator can depend on both links in the form Φ(Φᵤₚ, Φ_{down}). One may select e.g. an additive form

Φ[p,p′]=α[p,p′]φᵤₚ[p,p′]+(1−α[p,p′])φ_{down}[p,p′] (1)

where α[p,p′] represents the relative weight of up and downlink channels.

For example, if the uplink of a duplex link of user p has less data to send or otherwise demands less capacity than the downlink, then α[p,p′] can be made smaller than 1−α[p,p′]. The weight can also be used to reflect the relative time share of duplex links (dynamic switching point) when asymmetric services are used.

The a parameter can be set separately for each communication device or other node, user and/or service.

The weighted channel specific information can be used to ensure that e.g. different capacity requirements, for example how much data needs to be sent in uplink or downlink, is taken into consideration in the subchannel allocations. If, for example, downlink capacity requirement is greater than that of the uplink, a joint information can be computed by weighting uplink capacity with e.g. factor 0.9 and the downlink capacity with e.g. factor 0.1. If a particular user has no data to send in one direction the corresponding weight can be set to zero, and thus only information associated with the remaining direction affects the allocation for the particular user. This can be used, for example, to provide optimal subchannel allocation so that system capacity can be divided optimally among duplex directions.

As mentioned above, the weighting can be different for different users and/or subchannels. In accordance with certain embodiments different weights can be used to provide control of different subchannel and/or different direction link capacities in applications where a fixed switching point is used. Thus problems caused by varying switching points in multi-cell networks may be mitigated. Also, a different combining method can be used for different users and/or subchannels.

The different elements of the two matrices may use also different combining rules. For example, the combining rule may be such that additive combining is used for one subcarrier and multiplicative or non-additive combining is used for another subcarrier. Non-additive combining can be provided, for example, by functions taking the minimum or maximum of at least two measures, or by using any other nonlinear function, for example a product.

The joint performance indicator is captured in matrix Φ=[Φ_{p,p′}] and the allocation apparatus of the communication system can then allocate carriers appropriately for the users.

In an embodiment optimization of at least the subchannel indexes is provided. Subchannel indexes are provided to designate the subcarrier that is allocated to a certain user or service or data stream. The optimization can be provided within a constraint such as a fixed transmit time or fixed number of subcarriers.

As an example of this we consider a “sum-optimal” assignment that is posed as the assignment problem

$$1. max {\sum }_{p} {\sum }_{{p}^{′}} {φ}_{p , {p}^{′}} {t}_{p , {p}^{′}} \qquad ( 2 )$$

subject to

$$\begin{matrix}1. {\sum }_{p} {t}_{p , {p}^{′}} = 1 , ∀ {p}^{′} & ( 3 ) \\ {\sum }_{{p}^{′}} {t}_{p , {p}^{′}} = 1 , ∀ p , & ( 4 ) \\ {t}_{p , {p}^{′}} \geq 0 , ∀ p , {p}^{′} & ( 5 )\end{matrix}$$

Although decision variables in equation (5) are continuous, the optimal solution is known to be integral, where t_{p,p′} can be either 0 or 1. Variable t_{p,p′}=1 if user p transmits on carrier p and t_{p,p′}=0 otherwise. The constraints (3)-(4) formalize the requirement that each user is assigned to exactly one carrier. Thus, T=[t_{p,p′}] is a permutation matrix. The complexity of the classical primal-dual assignment algorithm for problem (2)-(5) is O(n⁴).

If the uplink and downlink, channels, required data rates and so on are different then it in a typical case follows that the uplink and downlink performance matrices are not identical either, as at least one element is different. Thus the information to be combined can be expected to be different for at least one matrix element, and simple duplication of information regarding one direction cannot be trusted to give a similar result.

It is noted that from the point of view of the embodiments similar results as obtainable by the exemplifying algorithm can be achieved by other means when providing joint use of information regarding the uplink and downlink and that there are several alternatives for combining channel and/or interference and/or performance related information from both uplink and downlink when assigning channels and/or slots. The way the elements or information in the matrices or otherwise is used depends on the application.

An element of the combined matrix can be selected so that it provides the maximum in respective element or elements in constituent matrices (e.g. if the duplex direction is selected opportunistically), or the minimum (or product) of respective elements (e.g. if channel assignment is attempts to equalize the performance in the duplex directions). There are naturally several variations of this.

It is also possible that Fᵤₚ is partially different from F_{Down}. This situation can occur e.g. if uplink and downlink operate on the same carrier at the same time as the system can optimize the subcarriers/subchannels separately for uplink and downlink communications. For example, this can occur in certain wideband systems with frequency domain scheduling.

In an OFDMA/TDD system, for example, a user can be assigned different, but correlated subcarriers in different directions. For example, neighbouring subcarriers can be highly correlated in an OFDM(A) system, depending on frequency coherence. In this case, a subchannel, but not generally interference, for example SIR, reciprocity can be assumed for these different subcarriers. The allocation can be computed e.g. using average channel state information over N neighbouring subchannels. Having allocated certain N neighbouring subchannels for a given duplex link, the number of subchannels to different directions may independently optimized for the link as long as at most N subchannels are allocated.

In TDD systems with perfect channel reciprocity, the physical channel is theoretically the same, but nevertheless the interference is different. Thus, an element of the performance matrix can be expressed as

$${φ}_{up / down} [ p , {p}^{′} ] = \frac{{\vert {h}_{up / down} [ p , {p}^{′} ] \vert}^{2}}{{{σ}_{up / down} [ p , {p}^{′} ]}^{2} + {n}_{up / down} [ p , {p}^{′} ]} \qquad ( 6 )$$

where h[p,p′] is the physical channel complex gain,

i. σ[p,p′]² is noise variance in a given receiver, and

n[p,p′] is the interference power at said receiver.

In TDD and FDD systems n[p,p′] and noise power are different in different locations and/or receivers. In TDD the channel complex gain is typically the same in both directions.

The method is not restricted to the performance indicator matrices given here as example. Rather, the performance indicators (or utilities) may be depend on coding and modulation, transmitter structures, antenna structures, receiver structures and algorithms, power budget, delay constraints, and so on.

In the computation the first node can be notated as node A and the second node as node B. If there are several nodes that need to be taken into consideration, it is possible to use simple notations A1, B1, A2, B2, and so on for the nodes in the required computations. One of these nodes may be common to other nodes, e.g. an element in a point-to-multipoint link, or vice versa.

The above described principles can be applied to a great number of different implementations of duplex communication links. The details of an application can depend on the entity where the channel and/or slot assignment is made and the apparatus by which the assignment is made.

Determining of appropriate subchannel(s) or carrier(s) can be made even more efficient by taking the total throughput of the system into consideration. The relative data rate demands in uplink and downlink can be taken into account when allocating channels. This can enable grant of a certain subchannel for duplex communication so that it is jointly optimal for both duplex directions. For example, if both duplex directions require certain minimum capacity the subchannels or carriers can be optimized based on the weaker duplex direction for a particular service or user. This is beneficial also because there typically is no benefit for using a higher capacity in just one direction. If the combined capacity is optimized then both duplex directions can be accounted for equally. If both links can be opportunistic, then the subchannels can be assigned using the maximum of these links, and so on.

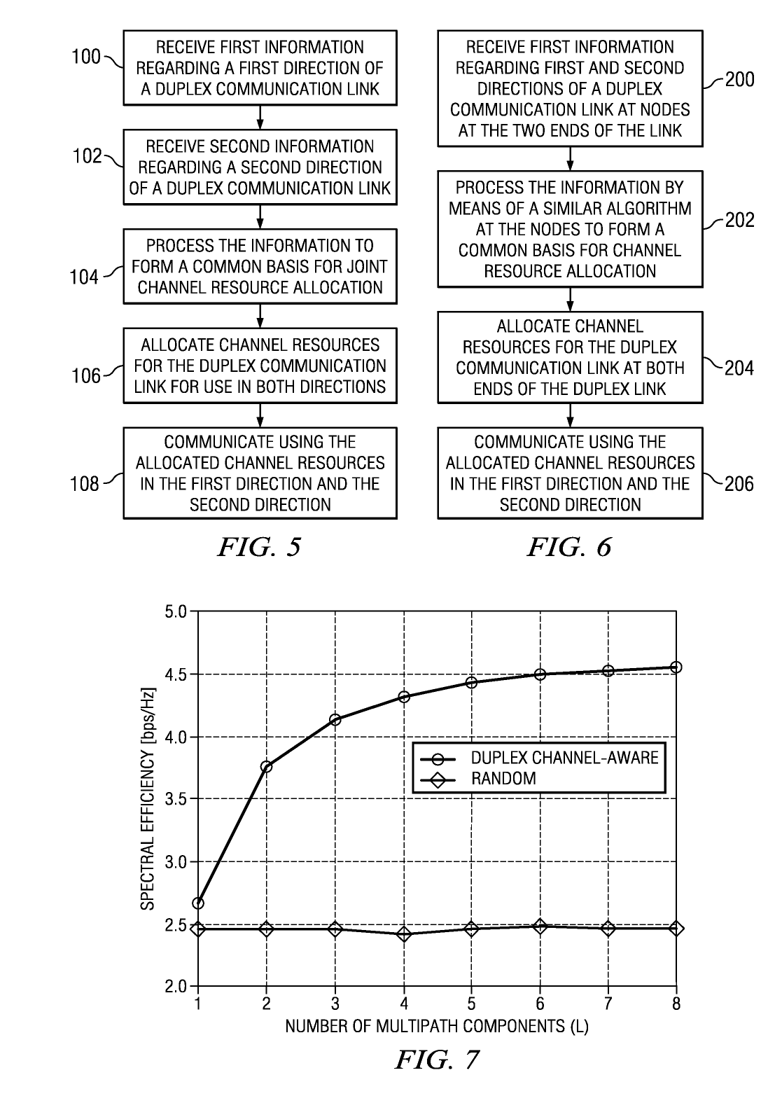

Operation in accordance with an exemplary embodiment is illustrated by the flowchart of FIG. 5. As shown, in a method in a multi-user communication environment first information regarding a first direction of a duplex communication link is received at 100. The first information can be received, for example, from a quality monitoring or other apparatus of a first node. Second information regarding a second direction of the duplex communication link is also received at 102. The second information can be received for example via a feedback channel from a second node. The first information and the second information are processed at 104, for example as described above, to produce basis for allocation of channel resources for the duplex link. A step of allocation of channel resources for the duplex communication link can then follow at 106. The allocation can be provided at least partially based on the results of said processing at 104. Communication may then be provided by means of the allocated channel resources in the first direction and the second direction at 108.

Operation in accordance with another embodiment is illustrated by the flowchart of FIG. 6. In this embodiment the first and second information is received at both ends of the link at 200. The first information and the second information are then processed at 202 at the both ends to produce basis for allocation of channel resources. A step of allocation of channel resources for the duplex communication link can then follow at 204, but so that each end is responsible on the allocation of one direction only. However, because the algorithm and the input(s) are the same, similar channel resource will be allocated at both ends. Communication may then be provided by means of the allocated channel resources in the first direction and the second direction at 206.

The required data processing apparatus and functions may be provided by means of one or more data processors. The above described functions may be provided by separate processors or by an integrated processor. The data processing may be distributed across several data processing modules. A data processor may be provided by means of, for example, at least one chip. Appropriate memory capacity can also be provided in the relevant nodes. An appropriately adapted computer program code product or products may be used for implementing the embodiments, when loaded on an appropriate data processing apparatus, for example in a processor apparatus 13 associated with the base station 10 shown in FIG. 1, by the apparatus 26, 27 of FIG. 2, and/or a data processing apparatus 2 and/or 9 of the communication device 1 of FIG. 3. The program code product for providing the operation may be stored on, provided and embodied by means of an appropriate carrier medium. An appropriate computer program can be embodied on any appropriate computer readable record medium. A possibility is to download the program code product via a data network.

The herein described principles can be applied in any system where channel reciprocity type duplexing methods is used, and where there are several possible channels and subchannels such as carriers, subcarriers, and time and/or frequency and other carrier slots in at least one direction of the duplex channel. Non-limiting examples of such systems include short range links such as those based on the IEEE 802.11 standards, for example WiFi by the Wi-Fi alliance, UWB (ultra wide band), Bluetooth™ and long-range links such as those based on WiMax (Worldwide Interoperability for Microwave Access) or cellular system such as example a second, third or fourth generation cellular systems (2G, 3G, 3.5 G, 4G), systems that are based on the long term evolution (LTE) concept, systems that are IEEE 802.16e compatible and similar.

Results of performance simulations in accordance with an exemplary embodiment are shown in FIG. 7. The algorithm used in the simulations worked based on relative channel preferences, i.e. the algorithm determined the best subcarrier and so on, and iteratively found at least N different subchannels for N different users. An assumption was that no two users were willing to change subchannels between them. The figure shows duplex capacity expressed as the average of the sum of spectral efficiencies of both duplex directions and signal to noise ratio (SNR) 3 dB per subcarrier in a TDD OFDMA system with eight subcarriers for a multipath channel parameterized with L=1, . . . , 8 taps. In the simulated case, the same subcarrier is used for both up and downlink communication and the channels are otherwise identical, except that each subcarrier in downlink is randomly punctured and has zero power with 15% probability to model interference.

From the exemplifying simulation results shown in FIG. 7 it can be concluded that when L=1 the channel for each user is flat and there appears to be no gain over a random assignment. When L=8 the subcarriers appear essentially independent and a noticeable improvement appears on the graph. The capacity may even be improved in the flat channel, since it can be possible to avoid interference from punctured subchannels. Based on the simulations it would appear that the duplex capacity can be increased when channel variations are increased, due to increased frequency selectivity with increasing number of channels.

It is noted that whilst embodiments have been described in relation to a base station and mobile user devices, similar principles can be applied to any other communication system where duplexing is employed. Therefore, although certain embodiments were described above by way of example with reference to certain exemplifying architectures for wireless networks, technologies and standards, embodiments may be applied to any other suitable forms of communication systems than those illustrated and described herein.

It is also noted herein that while the above describes exemplifying embodiments of the invention, there are several variations and modifications which may be made to the disclosed solution without departing from the spirit and scope of the present invention.

1. A method, comprising:
receiving first information regarding a first direction of a duplex communication link;
receiving second information regarding a second direction of the duplex communication link;
processing the first information and the second information; and
allocating channel resources for the first direction and the second direction of the duplex communication link based at least partially on said processing.

2. A method as claimed in claim 1, wherein the channel resource comprises at least one of a channel, subchannel, carrier frequency, a time slot, a time-frequency slot, a transmit beam, and a receive beam.

3. A method as claimed in claim 1, comprising determining a joint allocation parameter, and allocating resources based on the joint allocation parameter.

4. A method as claimed in claim 1, wherein said first and second information comprise at least one of channel information and interference information.

5. A method as claimed in claim 1, wherein said first and second information comprise channel specific information; the channel specific information comprise at least one of information regarding channel power, signal to interference ratio, bit error rate, channel capacity, channel throughput, channel utilization, channel specific buffer, channel quality, channel occupancy, channel availability, tolerable delay, channel state information, subchannel preferences, and data rate demands.

6. A method as claimed in claim 1, comprising weighting at least one of the first information and the second information.

7. A method as claimed in claim 1, wherein the processing comprises combining information based on at least one of additive, non-additive and multiplicative combining.

8. A method as claimed in claim 1, wherein the processing comprises combining performance matrices.

9. A method as claimed in claim 1, comprising determining the first information by a transmitting node, receiving the second information from a receiving node, and processing the first and second information in the transmitting node to provide said allocation of channel resources.

10. A method as claimed in claim 1, comprising receiving the second information via a feedback channel.

11. A method as claimed in claim 1, comprising allocation of resources for at least one other link based on said processing.

12. An apparatus, comprising:
a receiver configured to receive first information regarding a first direction of a duplex communication link; and
second information regarding a second direction of the duplex communication link; and
a processor configured to
process the first information and the second information; and
allocate channel resources for the first direction and the second direction of the duplex communication link based at least partially on said processing.

13. An apparatus as claimed in claim 12, wherein the channel resource comprises at least one of a channel, subchannel, carrier frequency, a time slot, and a time-frequency slot.

14. An apparatus as claimed in claim 12, further comprising a controller configured to determine a joint allocation parameter and allocate resources based on the joint allocation parameter.

15. An apparatus as claimed in claim 12, configured to allocate said channel resources based on channel specific information; the channel specific information comprise at least one of information regarding channel power, interference, signal to interference ratio, bit error rate, channel capacity, channel throughput, channel utilization, channel specific buffer, channel quality, channel occupancy, channel availability, tolerable delay, subchannel preferences, channel state information, and data rate demands.

16. An apparatus as claimed in claim 12, configured to apply a weight to at least one of the first information and the second information.

17. An apparatus as claimed in claim 12, configured to combine the first information and the second information based on at least one of additive, non-additive or multiplicative combining.

18. An apparatus as claimed in claim 12, configured to allocate resources for at least one other link based on said processing.

19. An apparatus comprising:
an interface configured to receive a first information regarding a first direction of a duplex communication link from a transmitting node and to send a second information regarding a second direction of the duplex communication to the transmitting node; and
at least one data processor configured to determine the second information, to process the first information and the second information, and to allocate channel resources for the second direction of the duplex communication link based at least partially on the processing.

20. An apparatus as claimed in claim 19, comprising a user equipment for communication in a multi-user environment.
